(19) United States
(12) Patent Application Publication
(10) Pub. No.: US 2008/0039342 A1
(43) Pub. Date: Feb. 14, 2008

(54) PROCESS FOR TRANSITION METAL-CATALYZED ELECTROCHEMICAL ALLYLIC ALKYLATION ON AN ELECTRODE ARRAY DEVICE

(75) Inventors: Jun Tian, St. Louis, MO (US); Kevin D. Moeller, Overland, MO (US); Sarah Wood, St. Louis, MO (US); Karl Maurer, Mukilteo, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: COMBIMATRIX CORPORATION, Mukilteo, WA (US)

(21) Appl. No.: 11/777,972

(22) Filed: Jul. 13, 2007

Related U.S. Application Data
(63) Continuation-in-part of application No. 11/326,717, filed on Jan. 7, 2006.
(60) Provisional application No. 60/642,011, filed on Jan. 7, 2005.

(51) Int. Cl. C40B 40/00; C25F 3/00

(52) U.S. Cl. 506/13; 205/640

(57) ABSTRACT

There is disclosed a process for performing an isolated Pd(0) catalyzed reaction electrochemically on an electrode array device. Specifically, there is disclosed a process for conducting an isolated Pd(0) catalyzed reaction on a plurality of electrodes, comprising providing an electrode array device having a matrix or coating material over metallic or conductive electrodes surfaces and a plurality of electrodes; providing a solution bathing the electrode array device, wherein the solution comprises a transition metal catalyst and a confining agent; and biasing one or a plurality of electrodes on the electrode array device with a voltage or current to regenerate the transition metal catalyst required for the isolated Pd(0) catalyzed reaction, whereby the confining agent limits diffusion of the transition metal catalyst to a volume surrounding each selected electrode surface.

### CROSS REFERENCE TO RELATED APPLICATION

This application is a continuation-in-part of U.S. patent application Ser. No. 11/326,717, filed Jan. 7, 2006, which claims the benefit of U.S. Provisional Application No. 60/642,011, filed Jan. 7, 2005. Each application is incorporated herein by reference in its entirety.

### TECHNICAL FIELD OF THE INVENTION

The present invention provides a process for performing an isolated Pd(0) catalyzed reaction electrochemically on an electrode array device. Preferably the Pd(0) catalyzed reaction is a Heck reaction. Specifically, the inventive process provides a process for conducting an isolated Pd(0) catalyzed reaction on a plurality of electrodes, comprising providing an electrode array device having a matrix or coating material over metallic or conductive electrodes surfaces and a plurality of electrodes; providing a solution bathing the electrode array device, wherein the solution comprises a transition metal catalyst and a confining agent; and biasing one or a plurality of electrodes on the electrode array device with a voltage or current to regenerate the transition metal catalyst required for the isolated Pd(0) catalyzed reaction, whereby the confining agent limits diffusion of the transition metal catalyst to a volume surrounding each selected electrode surface.

### BACKGROUND OF THE INVENTION

Electronically addressable chip-based molecular libraries (Lipshutz et al., Nature Genetics 21:20, 1999; Pirrung, Chem. Rev. 97:473, 1997; Webb et al., J. Steroid Biochem. Mol. Biology 85:183, 2003; Shih et al., J. Virological Methods 111:55, 2003) have long been desired but have not been created. CombiMatrix Corporation scientists have been utilizing active-semiconductor electrode arrays that incorporate individually addressable microelectrodes to synthesize oligonucleotide and polypeptide molecules (U.S. Pat. No. 6,093,302; WO/0053625; Oleinikov et al., J. Proteome Res. 2:313, 2003; Sullivan et al., Anal. Chem. 71:369, 1999; Zhang et al., Anal. Chim. Acta 421:175, 2000; and Hintsche et al., Electroanal. 12:660, 2000).

In this way, each unique set of molecules in a library can be located proximal to a unique electrode or set of electrodes that can in turn be used to monitor their behavior (Dill et al., Analytica Chimica Acta 444:69, 2001). This is accomplished by coating the electrode-containing devices with a porous polymer and then utilizing the electrodes to both attach monomers to the chips and then generate reagents capable of performing reactions on the monomers.

The Heck reaction is a powerful synthetic tool that allows for the efficient generation of new carbon—carbon bonds. The availability of a Heck reaction on an electrode array device would dramatically expand the types of molecules that could be constructed within a volume proximal to an electrode surface. Such a tool would allow for massively parallel electrochemical synthesis in small volumes on an electrode array device and create arrays containing highly diverse libraries of chemical compounds that are different from each other yet synthesized in parallel. Such combinatorial libraries could be synthesized rapidly, in small volumes and highly diverse. Therefore, there is a need in the art to be able to rapidly create diverse chemical libraries on a single solid electrode array device for large scale screening of combinatorial libraries. The present invention was made to address this need in the art.

Moreover, the Heck reaction represents a unique challenge for a site-selective reaction on an electrode array device because it is catalytic with respect to Pd(0).

### SUMMARY OF THE INVENTION

The present invention provides a process for conducting an isolated Pd(0) catalyzed reaction on a plurality of electrodes, comprising:

(a) providing an electrode array device having a matrix or coating material over metallic or conductive electrodes surfaces and a plurality of electrodes;

(b) providing a solution bathing the electrode array device, wherein the solution comprises a transition metal catalyst, and a confining agent;

(c) biasing one or a plurality of electrodes on the electrode array device with a voltage or current to regenerate the transition metal catalyst consumed during the Pd(0) catalyzed reaction, whereby the confining agent limits diffusion of the transition metal catalyst to a volume surrounding each selected electrode surface.

Preferably, the isolated Pd(0) catalyzed reaction is selected from the group consisting of a Heck reaction, a Suzuki coupling reaction, displacement of an aryl halide with an RS-nucleophile of NH₂R nucleophile, coupling an aryl bromide to an aluminoacetylene Al (C≡C—R)₄ Na salt, displacement of an aryl halide with an esterenolate, alkyl group Suzuki coupling (aryl boron reagent with alkyl halide), Stille coupling R—X plus R′SnR″₃, alkyne-BF₃ salt coupling to aryl triflate halide, vinyl-BF₃ salt or alkyne-BF₃ salt coupling, reaction of an alcohol with alkyl/allyl carbonate to make alcohol allyl ether, conversion of an alpha aminoacetylene to a ketene, conversion of Ar—X plus acid chloride to acetylinic ketone, and combinations thereof.

Preferably, the transition metal catalyst for an isolated Pd(0) catalyzed reaction is a palladium (Pd) or a platinum (Pt) catalyst system. Most preferably, a Pd catalyst is stabilized with stabilizer selected from the group consisting of a phosphine ligand, a phosphite ligand, an arsenic derivative, a triphenylphosphine ligand, and combinations thereof. Most preferably, the Pd catalyst is stabilized by a triphenylphosphine ligand.

Preferably, the confining agent is an oxidant added to solution sufficient to convert Pd(0) back to Pd(II). Most preferably, the confining agent is an oxidant selected from the group consisting of substituted or unsubstituted allyl alkyl carbonates, allyl acetate, O2, peroxides, quinines, and combinations thereof. More preferably, the confining agent is a substituted or unsubstituted allyl alkyl carbonate wherein the alkyl moiety can be a C₁₋₆ alkyl group. Preferably, the biasing step used a voltage no greater than 2.4 V. Preferably, the biasing step was performed for a time of from about 1 sec to 3 min.

In another aspect, the present invention provides a process for conducting an isolated transition metal-catalyzed allylic alkylation reaction on a plurality of electrodes. In one embodiment, the process comprises:

(a) contacting an electrode array device with a solution comprising a transition metal catalyst in an inactive state, a confining agent, an electrolyte, and a nucleophile, wherein the electrode array device comprises a plurality of individually addressable electrodes, each electrode having an allylic substrate immobilized proximally thereto; and

(b) selectively biasing one or more of the electrodes with a voltage or current to reduce the transition metal catalyst in an inactive state to provide a transition metal catalyst in an active state, wherein the transition metal catalyst in the active state catalyzes the covalent coupling of the nucleophile to the allylic substrate to provide an immobilized allylic alkylation product.

The transition metal catalyst can be a palladium, platinum, nickel, or cobalt catalyst. The catalyst can be stabilized with a ligand, such as a phosphine ligand, a phosphite ligand, an arsenic derivative, a triphenylphosphine ligand, metal carbonyl, and combinations thereof.

The confining agent limits diffusion of the transition metal catalyst in the active state away from a volume surrounding each electrode to prevent the catalytic reaction from occurring away from electrodes that are activated with a voltage or current. The confining agent is an oxidant present in the solution in an amount effective to convert the catalyst in the active state to the transition metal catalyst in the inactive state. In one embodiment, the confining agent is quinone.

In the process of the invention, a nucleophile is covalently coupled to an allylic substrate immobilized on an electrode. In one embodiment, the nucleophile is a compound having a doubly activated methylene group, an alcohol, or an amine nucleophile. In one embodiment, the nucleophile is a β-ketoester. Representative allylic substrates include allyl carbonates, allyl halides, and allyl esters.

In one embodiment, the electrolyte is tetrabutylammonium bromide.

In a further aspect of the invention, a process for attaching an allylation substrate proximally to a plurality of electrodes is provided. In one embodiment, the method includes:

(a) contacting an electrode array device with an organic solution comprising an allylation substrate, a base, and an electrolyte, wherein the electrode array device comprises a plurality of individually addressable electrodes, each having a porous reaction layer proximal thereto, wherein the porous reaction layer has reactive hydroxyl groups; and

(b) selectively biasing one or more of the electrodes with a voltage or current to provide a reduced base, wherein the reduced base triggers a based-catalyzed esterification reaction between the porous reaction layer and the allylation substrate, whereby the allylation substrate attaches to the porous reaction layer.

In another aspect, the invention provides a microarray having a plurality of allylation substrates attached thereto. In one embodiment, the microarray includes:

(a) a substrate having a plurality of known locations;

(b) a porous reaction layer attached to the substrate and covering the known locations; and

(c) a plurality of allylation substrates attached to the porous reaction layer at the known locations.

### BRIEF DESCRIPTION OF THE DRAWINGS

FIG. 1 shows a an electrode array surface under a fluorescent scanner device (Axon Instruments) wherein 1-pyrenemethylacrylate was deposited at selected electrode sites using electrodes as cathodes to reduce Pd(II) to Pd(0). The Pd(0) triggered a Heck reaction between the substrate and the aryl iodide on the surface of the selected electrodes (selected to form a square pattern with an electrode in the middle). The bright spots are the selected electrodes with 1-pyrenemethylacrylate as an indicator.

FIG. 2 shows the design of the experiment performed in Example 1.

FIG. 3 shows the synthetic scheme for the experiment. In the first step an aryl iodide is placed on the chips surface using the same methodology employed in earlier studies (Tesfu et al., J. Am. Chem. Soc. 126:6212, 2004). To this end, all of the electrodes on the electrode array device were utilized as cathodes in order to reduce vitamin B₁₂. This effectively generated a base. The base served to catalyze an esterification reaction between the hydroxyl groups of the polysaccharide polymer coating the electrode array device and the N-hydroxysuccinimide ester of 4-iodobenzoic acid. The effect of this process was to concentrate the aryl iodide substrate near the electrodes on the electrode array device. The second step in the sequence is the Heck reaction. The Heck reaction is performed by submerging the electrode array device in a 2:7:1 DMF/MeCN/H₂O solution containing Pd(0Ac)₂, triphenyl-phosphine, triethylamine, allyl methyl carbonate, and tetrabutyl-ammonium bromide electrolyte. Selected electrodes were turned on as cathodes at a voltage of −2.4 V (relative to a Pt auxiliary electrode as an anode) in order to generate a box pattern of electrodes on the array with a dot in the center. The electrodes (Pt surface) were cycled for 0.5 sec on and then 0.1 sec off for 3 min.

FIG. 4 is a schematic illustration of a palladium (0) catalyzed allylic alkylation reaction to site-selectively couple a β-ketoester to an immobilized allylic carbonate on the surface of a microelectrode.

FIG. 5 illustrates the solution phase allylic alkylation reaction using allyl bromide (X═Br), allyl acetate (X═OAc), and allyl carbonate (X═OC(O)OR) as the allylic substrates.

FIG. 6 illustrates the synthesis of representative N-hydroxysuccinimde esters useful for electrode immobilization to provide immobilized allylic substrates.

FIG. 7 is a schematic illustration of a representative method for preparing an electrode-immobilized allylic substrate by esterification using suitable N-hydroxysuccinimide esters.

FIG. 8 illustrates the site-selective coupling of a representative β-ketoester to an allylic substrate immobilized on the surface of a microelectrode by palladium(0)-catalyzed allylic alkylation reaction.

FIGS. 9A and 9B are fluorescence microscope images of a microarray of electrodes following an allylic alkylation reaction. FIG. 9A is the fluorescence microscope image of a microarray following an allylic alkylation reaction with allyl acetate as the substrate; and FIG. 9B is the fluorescence microscope image of a microarray following an allylic alkylation reaction with allyl carbonate as the substrate.

### DETAILED DESCRIPTION OF THE INVENTION

In the exemplified experiments Pd(II) was reduced to Pd(0) at selected electrodes on the electrode array device. Further, a confining agent was necessary to confine the reaction to the region surrounding a selected electrode. Allyl methyl carbonate was a preferred confining agent. This is because the reaction performed without the preferred confining agent, allyl methyl carbonate, led to significant spreading of fluorescent signal away from selected electrode sites.

The reagents generated at any given electrode were confined to the area surrounding the electrode by placing a substrate in the solution above the electrode that consumed the reagent. Briefly, this process was described in connection with the generation of acids and bases confined to a volume on electrode array devices (see, for example, Montgomery U.S. Pat. No. 6,093,302, the disclosure of which is incorporated by reference herein). In previous work, a Pd(II) reagent was generated electrochemically and confined to a region surrounding an electrode (Tesfu et al., J. Am. Chem. Soc. 126:6212, 2004). The Pd(II) reagent was generated by utilizing the electrodes on an electrode array device as anodes to oxidize a Pd(0) reagent added to the solution above the electrode array device. The Pd(II) reagent generated was confined to the electrode sites of its generation with the use of ethyl vinyl ether. The feasibility of this process was demonstrated by performing a Wacker oxidation at selected electrodes on the electrode array.

The present invention was motivated by the desire to determine if the electrodes be used as cathodes in order to reduce a Pd(II) reagent to a Pd(0) reagent at pre-selected sites on a microarray device having a plurality of electrode sites (each separately addressable). The problem solved by the present invention was to find an efficient confinement strategy for the Pd(0) reagent generated so that it was confined to one electrode and did not catalyze a reaction at a neighboring electrode. This is necessary in order to be able to perform the Heck reaction (a Pd(0) catalyzed reaction) at selected electrode sites while avoiding the reaction at non-selected electrode sites.

In the case of the earlier Wacker oxidation, Pd(II) was used as a stoichiometric oxidant. Hence, most of the reagent generated at a selected electrode on an electrode array was consumed by the reaction. Ethyl vinyl ether added to the solution (bathing the electrode array device) effectively confined the Pd(II) generated by scavenging any excess reagent. Such is not the case for the proposed Heck reaction or other Pd(0) catalyzed reactions. In this case, the reaction did not consume the Pd(0) catalyst. A confining agent was needed to keep all of the reagent generated from migrating to areas of the electrode array device where it was not wanted. In other words, rather than use an electrolysis reaction to make a normally stoichiometric reaction catalytic as in a normal mediated electrolysis, for the Heck reaction the electrode array-based environment must be used to make a normally catalytic reaction stoichiometric thereby confining the catalyst to pre-selected sites on the selected electrode of the array.

The present invention provides a process for conducting a parallel Heck reaction on a plurality of electrodes, comprising

(a) providing an electrode array device having a matrix or coating material over metallic or conductive electrodes surfaces and a plurality of electrodes;

(b) providing a solution bathing the electrode array device, wherein the solution comprises a transition metal catalyst, and a confining agent;

(c) biasing one or a plurality of electrodes on the electrode array device with a voltage or current to regenerate the transition metal catalyst consumed during the Heck reaction, whereby the confining agent limits diffusion of the transition metal catalyst to a volume surrounding each selected electrode surface.

The present invention further provides a process for conducting an isolated Pd(0) catalyzed reaction on a plurality of electrodes, comprising:

(a) providing an electrode array device having a matrix or coating material over metallic or conductive electrodes surfaces and a plurality of electrodes;

(b) providing a solution bathing the electrode array device, wherein the solution comprises a transition metal catalyst, and a confining agent;

(c) biasing one or a plurality of electrodes on the electrode array device with a voltage or current to regenerate the transition metal catalyst consumed during the Pd(0) catalyzed reaction, whereby the confining agent limits diffusion of the transition metal catalyst to a volume surrounding each selected electrode surface.

Preferably, the isolated Pd(0) catalyzed reaction is selected from the group consisting of a Heck reaction, a Suzuki coupling reaction, displacement of an aryl halide with an RS-nucleophile of NH₂R nucleophile, coupling an aryl bromide to an aluminoacetylene Al (C≡C—R)₄ Na salt, displacement of an aryl halide with an esterenolate, alkyl group Suzuki coupling (aryl boron reagent with alkyl halide), Stille coupling R—X plus R′SnR″₃, alkyne-BF₃ salt coupling to aryl triflate halide, vinyl-BF₃ salt or alkyne-BF₃ salt coupling, reaction of an alcohol with alkyl/allyl carbonate to make alcohol allyl ether, conversion of an alpha aminoacetylene to a ketene, conversion of Ar—X plus acid chloride to acetylinic ketone, and combinations thereof. Preferably, a Pd catalyst is stabilized with stabilizer selected from the group consisting of a phosphine ligand, a phosphite ligand, an arsenic derivative, a triphenylphosphine ligand, and combinations thereof. Most preferably, the Pd catalyst is stabilized by a triphenylphosphine ligand.

Preferably, the confining agent is an oxidant added to solution sufficient to convert Pd(0) back to Pd(II). Most preferably, the confining agent is an oxidant selected from the group consisting of substituted or unsubstituted allyl alkyl carbonates, allyl acetate, O2, peroxides, quinines, and combinations thereof. More preferably, the confining agent is a substituted or unsubstituted allyl alkyl carbonate wherein the alkyl moiety can be a C₁₋₆ alkyl group. Preferably, the biasing step used a voltage no greater than 2.4 V. Preferably, the biasing step was performed for a time of from about 1 sec to 3 min.

Preferably, the transition metal catalyst for a Heck reaction is a palladium (Pd) or a platinum (Pt) catalyst system.

The term “substituted” or “substitution,” in the context of a moiety of the confining agent, means a moiety independently selected from the group consisting of (1) the replacement of a hydrogen on at least one carbon by a monovalent radical, (2) the replacement of two hydrogens on at least one carbon by a divalent radical, (3) the replacement of three hydrogens on at least one terminal carbon (methyl group) by a trivalent radical, (4) the replacement of at least one carbon and the associated hydrogens (e.g., methylene group) by a divalent, trivalent, or tetravalent radical, and (5) combinations thereof. Meeting valence requirements restricts substitution. Substitution occurs on alkyl, alkenyl, alkynyl, cycloalkyl, cycloalkenyl, cycloalkynyl, aryl, heterocyclic ring, and polycyclic groups, providing substituted alkyl, substituted alkenyl, substituted alkynyl, substituted cycloalkyl, substituted cycloalkenyl, substituted cycloalkynyl, substituted aryl group, substituted heterocyclic ring, and substituted polycyclic groups.

The groups that are substituted on an alkyl, alkenyl, alkynyl, cycloalkyl, cycloalkenyl, cycloalkynyl, aryl, heterocyclic ring, and polycyclic groups are independently selected from the group consisting of alkyl, alkenyl, alkynyl, cycloalkyl, cycloalkenyl, cycloalkynyl, aryl, heterocyclic ring, polycyclic group, halo, heteroatom group, oxy, oxo, carbonyl, amide, alkoxy, acyl, acyloxy, oxycarbonyl, acyloxycarbonyl, alkoxycarbonyloxy, carboxy, imino, amino, secondary amino, tertiary amino, hydrazi, hydrazino, hydrazono, hydroxyimino, azido, azoxy, alkazoxy, cyano, isocyano, cyanato, isocyanato, thiocyanato, fulminato, isothiocyanato, isoselenocyanato, selenocyanato, carboxyamido, acylimino, nitroso, aminooxy, carboximidoyl, hydrazonoyl, oxime, acylhydrazino, amidino, sulfide, thiol, sulfoxide, thiosulfoxide, sulfone, thiosulfone, sulfate, thiosulfate, hydroxyl, formyl, hydroxyperoxy, hydroperoxy, peroxy acid, carbamoyl, trimethyl silyl, nitrilo, nitro, aci-nitro, nitroso, semicarbazono, oxamoyl, pentazolyl, seleno, thiooxi, sulfamoyl, sulfenamoyl, sulfeno, sulfinamoyl, sulfino, sulfinyl, sulfo, sulfoamino, sulfonato, sulfonyl, sulfonyldioxy, hydrothiol, tetrazolyl, thiocarbamoyl, thiocarbazono, thiocarbodiazono, thiocarbonohydrazido, thiocarbonyl, thiocarboxy, thiocyanato, thioformyl, thioacyl, thiosemicarbazido, thiosulfino, thiosulfo, thioureido, thioxo, triazano, triazeno, triazinyl, trithio, trithiosulfo, sulfinimidic acid, sulfonimidic acid, sulfinohydrazonic acid, sulfonohydrazonic acid, sulfinohydroximic acid, sulfonohydroximic acid, and phosphoric acid ester, and combinations thereof.

As an example of a substitution, replacement of one hydrogen or ethane by a hydroxyl provides ethanol, and replacement of two hydrogens by an oxo on the middle carbon of propane provides acetone (dimethyl ketone.) As a further example, replacement the middle carbon (the methenyl group) of propane by the oxy radical (—O—) provides dimethyl ether (CH₃—O—CH₃.) As a further example, replacement of one hydrogen on a benzene by a phenyl group provides biphenyl.

As provided above, heteroatom groups can be substituted inside an alkyl, alkenyl, or alkylnyl group for a methylene group (:CH₂) thus forming a linear or branched substituted structure rather than a ring or can be substituted for a methylene inside of a cycloalkyl, cycloalkenyl, or cycloalkynyl ring thus forming a heterocyclic ring. As a further example, nitrilo (—N═) can be substituted on benzene for one of the carbons and associated hydrogen to provide pyridine, or and oxy radical can be substituted to provide pyran.

The term “unsubstituted” means that no hydrogen or carbon has been replaced on an alkyl, alkenyl, alkynyl, cycloalkyl, cycloalkenyl, cycloalkynyl, or aryl group.

It was noted that the use of triphenylphosphine as a ligand for the palladium was important for keeping the Pd(0) generated at the cathode (electrode) from plating out on the electrode array device. Preferably, some DMF was added the reaction mixture to further allow a Heck reaction to proceed. However, the reaction could not be done using DMF/H₂O as solvent. Without being bound by theory, it is anticipated that the DMF caused cleavage occurs due to base generated from either the reaction of Pd(0) with the allyl methyl carbonate the reduction of water at the cathode. Further still, the presence of a confining agent was necessary. A reaction without the allyl methyl carbonate led to significant spreading of the fluorescence away from the selected electrodes.

We found that voltages higher than −2.4V or reaction times longer than three minutes led to a decrease in the intensity of the product spots on the electrode array device. Apparently, the harsher conditions or longer reaction times led to cleavage of the newly formed pyrene product from the electrode array device. Without being bound by theory, this cleavage occurred due to base generated from either the reaction of Pd(0) with allyl methyl carbonate (Tsuji and Minami, Acc. Chem. Res. 20:140, 1987) or reduction of water at the cathode.

Example 1 supports the conclusion that a Heck reaction (that is a preferred Pd(0) catalyzed reaction) has been performed at pre-selected sites on an electrochemically-addressable electrode array device. The experiment highlights the utility of a Pd(0) reagent on the electrode array device, and for the first time demonstrates the potential for employing a transition metal catalyst to selectively construct molecules proximal to specific addressable electrodes.

In another aspect, the present invention provides a process for conducting an isolated transition metal-catalyzed allylic alkylation reaction on a plurality of electrodes in a microarray format. In the method, a transition metal catalyst in an inactive state is electrochemically reduced at one or more selected electrodes of the microarray to provide a transition metal catalyst in an active state. The transition metal catalyst in the active state catalyzes the covalent coupling of a nucleophile in solution to an allylic substrate previously immobilized on the one or more electrodes to provide an immobilized allylic alkylation product proximate to the selected electrodes. The method provides for carbon-carbon bond formation between the nucleophile and allylic substrate resulting in alkylation of the allylic substrate.

In one embodiment, the process includes the steps of:

(a) contacting an electrode array device with a solution comprising a transition metal catalyst in an inactive state, a confining agent, an electrolyte, and a nucleophile, wherein the electrode array device comprises a plurality of individually addressable electrodes, each electrode having an allylic substrate immobilized proximally thereto; and

(b) selectively biasing one or more of the electrodes with a voltage or current to reduce the transition metal catalyst in an inactive state to provide a transition metal catalyst in an active state, wherein the transition metal catalyst in the active state catalyzes the covalent coupling of the nucleophile to the allylic substrate to provide an immobilized allylic alkylation product.

Any transition metal catalyst that is capable of catalyzing an allylic alkylation is useful in the method. Representative transition metal catalysts include palladium (Pd), platinum (Pt), nickel (Ni), and cobalt (Co) catalysts. In one embodiment, the transition metal catalyst is a palladium catalyst with Pd(0) as the active state and Pd(II) as the inactive state. In one embodiment, the transition metal catalyst is a nickel catalyst with Ni(0) as the active state and Ni(II) as the inactive state. In one embodiment, the transition metal catalyst is a cobalt catalyst with Co(0) as the active state and Co(II) as the inactive state.

The active state transition metal catalyst can be stabilized with a ligand stabilizer. Representative stabilizers useful in the method are ligands, such as a phosphine ligand, a phosphite ligand, an arsenic ligand, a triphenylphosphine ligand, metal carbonyl, and combinations thereof. In one embodiment, the catalyst is stabilized by a triphenylphosphine ligand.

The confining agent is used to limit diffusion of the active state transition metal catalyst to a volume surrounding each selectively biased electrode. By confining the active state catalyst to the volume surrounding the electrode, chemical selectivity is achieved and alkylation occurs only at the selectively biased electrode. In one embodiment, the confining agent is an oxidant present in the solution in an amount effective to convert the transition metal catalyst from the active (reduced) state to the oxidized inactive state (e.g., converts Pd(0) to Pd(II)). In one embodiment, the confining agent is quinone.

In one embodiment, the method provides for covalent coupling (new carbon-carbon bond formation) of a nucleophile to an allylic substrate immobilized on an electrode. Representative nucleophiles are carbon nucleophiles (i.e., nucleophilic carbanions) that can be alkylated. In one embodiment, the nucleophile is a compound having a doubly activated methylene group (i.e., the methylene group is activated by two electron-withdrawing groups).

In one embodiment, the nucleophile is a β-ketoester. Other suitable nucleophiles include alcohols and amines that can be alkylated.

The allylic substrate useful in the method can be any compound containing an allylic functionality, such as an allyl halide, an allyl ester, or an allyl carbonate, that can be covalently coupled to a nucleophile by a transition metal-catalyzed alkylation reaction. In one embodiment, the allylic substrate is an allyl acetate. In one embodiment, the allylic substrate is an allyl bromide. In one embodiment, the allylic substrate is an allyl carbonate.

In the method, one or more of the individually addressable electrodes in the electrode array device are selectively biased to convert the transition metal catalyst in the vicinity of the selected electrode from the inactive state to the active state. In one embodiment, one or more of the electrodes are biased with a voltage by applying a voltage less than about 2.4 V in absolute value. In another embodiment, one or more of the electrodes are biased with a voltage by applying a voltage less than about 3.0 V in absolute value. Higher voltages may be used provided that the electronic circuits of the microarray will not be damaged by the higher voltages. In one embodiment, one or more of the electrodes are biased with a voltage for a time period of from about 0.5 sec to about 3 min. Longer times may be used, and more confining reagent may be required for longer times. In one embodiment, the electrodes are cycled on for 0.5 sec and off for 0.1 sec for 300 cycles.

In one embodiment, the electrolyte is tetrabutylammonium bromide. In one embodiment, the electrolyte is tetrabutylammonium hexafluorophosphate. Any organic salt or ionic liquid that provides conductivity to the organic solvent is suitable and falls within the scope of the present invention. Without being bound by theory, such other organic salts or ionic liquids may be classified as imidazolium derivatives, pyridinium derivatives, quaternary ammonium derivatives, phosphonium derivatives, pyrrolidinium derivatives, guanidinium derivatives, uronium derivatives, and thiouronium derivatives.

The following is a list of examples of organic salts and ionic liquids suitable for use in the inventive formulations and processes, including, for example, 1,1-dibutyl-pyrrolidinium bis(trifluoromethylsulfonyl)imide, 1,1-dimethyl-pyrrolidinium tris(pentafluoroethyl)trifluorophosphate, 1,1-dipropyl-pyrrolidinium bis(trifluoromethylsulfonyl)imide, 1,2-dimethyl-3-propylimidazolium bis(trifluoromethylsulfonyl)imide, 1,2-dimethyl-3-propylimidazolium tris(trifluoromethylsulfonyl)methide, 1,3-dimethyl-imidazolium bis(pentafluoroethyl)phosphinate, 1,3-dimethyl-imidazolium methyl sulfate, 1,3-dimethyl-imidazolium trifluoromethanesulfonate, 1-benzyl-3-methyl-imidazolium hexafluoroantimonate, 1-benzyl-3-methyl-imidazolium hexafluorophosphate, 1-benzyl-3-methyl-imidazolium methylsulfate, 1-benzyl-3-methyl-imidazolium tetrafluoroborate, 1-benzyl-3-methyl-imidazolium trifluoromethanesulfonate, 1-butyl-1-methyl-pyrrolidinium bis(trifluoromethylsulfonyl)imide, 1-butyl-1-methyl-pyrrolidinium dicyanamide, 1-butyl-1-methyl-pyrrolidinium hexafluoroantimonate, 1-butyl-1-methyl-pyrrolidinium hexafluorophosphate, 1-butyl-1-methyl-pyrrolidinium methylsulfate, 1-butyl-1-methyl-pyrrolidinium tetracyanoborate, 1-butyl-1-methyl-pyrrolidinium tetrafluoroborate, 1-butyl-1-methyl-pyrrolidinium trifluoromethanesulfonate, 1-butyl-1-methyl-pyrrolidinium tris(pentafluoroethyl)trifluorophosphate, 1-butyl-2,3-dimethyl-imidazolium hexafluoroantimonate, 1-butyl-2,3-dimethyl-imidazolium hexafluorophosphate, 1-butyl-2,3-dimethyl-imidazolium methylsulfate, 1-butyl-2,3-dimethyl-imidazolium tetrafluoroborate, 1-butyl-2,3-dimethyl-imidazolium tosylate, 1-butyl-2,3-dimethyl-imidazolium trifluoromethanesulfonate, 1-butyl-3-ethyl-imidazolium trifluoromethanesulfonate, 1-butyl-3-methyl-imidazolium 2-(2-methoxyethoxy)ethyl sulfate, 1-butyl-3-methyl-imidazolium bis(trifluoromethyl)imide, 1-butyl-3-methyl-imidazolium cobalt tetracarbonyl, 1-butyl-3-methyl-imidazolium dicyanamide, 1-butyl-3-methyl-imidazolium hexafluorophosphate, 1-butyl-3-methyl-imidazolium methyl sulfate, 1-butyl-3-methyl-imidazolium octylsulfate, 1-butyl-3-methyl-imidazolium tetrafluoroborate, 1-butyl-3-methyl-imidazolium tosylate, 1-butyl-3-methyl-imidazolium trifluoroacetate, 1-butyl-3-methyl-imidazolium trifluoromethane sulfonate, 1-butyl-3-methyl-pyridinium bis(trifluormethylsulfonyl)imide, 1-butyl-4-methyl-pyridinium hexafluorophosphate, 1-butyl-4-methyl-pyridinium tetrafluoroborate, 1-butyl-imidazolium hexafluorophosphate, 1-butyl-imidazolium tetrafluoroborate, 1-butyl-imidazolium tosylate, 1-butyl-imidazolium trifluoromethanesulfonate, 1-ethyl-1-methyl-pyrrolidinium bis(trifluoromethyl)imide, 1-ethyl-1-methyl-pyrrolidinium hexafluoroantimonate, 1-ethyl-1-methyl-pyrrolidinium hexafluorophosphate, 1-ethyl-1-methyl-pyrrolidinium methylsulfate, 1-ethyl-1-methyl-pyrrolidinium tetrafluoroborate, 1-ethyl-1-methyl-pyrrolidinium trifluoromethanesulfonate, 1-ethyl-2,3-dimethyl-imidazolium hexafluoroantimonate, 1-ethyl-2,3-dimethyl-imidazolium hexafluorophosphate, 1-ethyl-2,3-dimethyl-imidazolium methylsulfate, 1-ethyl-2,3-dimethyl-imidazolium tetrafluoroborate, 1-ethyl-2,3-dimethyl-imidazolium tosylate, 1-ethyl-2,3-dimethyl-imidazolium trifluoromethanesulfonate, 1-ethyl-3-methyl-imidazolium bis(pentafluoroethyl)phosphinate, 1-ethyl-3-methyl-imidazolium bis(pentafluoroethylsulfonyl)imide, 1-ethyl-3-methyl-imidazolium bis(trifluoromethyl)imide, 1-ethyl-3-methyl-imidazolium bis(trifluoromethylsulfonyl)imide, 1-ethyl-3-methyl-imidazolium bis[1,2-benzenediolato(2-)-O,O′]-borate, 1-ethyl-3-methyl-imidazolium bis[oxalato(2-)]-borate, 1-ethyl-3-methyl-imidazolium cobalt tetracarbonyl, 1-ethyl-3-methyl-imidazolium dicyanamide, 1-ethyl-3-methyl-imidazolium hexafluoroantimonate, 1-ethyl-3-methyl-imidazolium hexafluorophosphate, 1-ethyl-3-methyl-imidazolium nitrate, 1-ethyl-3-methyl-imidazolium tetrafluoroborate, 1-ethyl-3-methyl-imidazolium tosylate, 1-ethyl-3-methyl-imidazolium trifluoroacetate, 1-ethyl-3-methyl-imidazolium trifluoromethanesulfonate, 1-ethyl-3-methyl-imidazolium trifluoromethyltrifluoroborate, 1-hexyl-1-methyl-pyrrolidinium bis(trifluoromethylsulfonyl)imide, 1-hexyl-1-methyl-pyrrolidinium dicyanamide, 1-hexyl-2,3-dimethyl-imidazolium tetrafluoroborate, 1-hexyl-2,3-dimethyl-imidazolium trifluoromethanesulfonate, 1-hexyl-3-methyl-imidazolium bis(trifluoromethylsulfonyl)imide, 1-hexyl-3-methyl-imidazolium bis(trifluoromethylsulfonyl)methane, 1-hexyl-3-methyl-imidazolium dicyanamide, 1-hexyl-3-methyl-imidazolium hexafluoroantimonate, 1-hexyl-3-methyl-imidazolium hexafluorophosphate, 1-hexyl-3-methyl-imidazolium methylsulfate, 1-hexyl-3-methyl-imidazolium tetracyanoborate, 1-hexyl-3-methyl-imidazolium tetrafluoroborate, 1-hexyl-3-methyl-imidazolium trifluoromethanesulfonate, 1-hexyl-3-methyl-imidazolium tris(heptafluoropropyl)trifluorophosphate, 1-hexyl-3-methyl-imidazolium tris(pentafluoroethyl)trifluorophosphate, 1-hexyl-3-methyl-imidazolium tris(pentafluoroethyl)trifluorophosphate, 1-methyl-3-(3,3,4,4,5,5,6,6,7,7,8,8,8-tridecafluoroctyl)-imidazolium-hexafluorophosphate, 1-methyl-3-octyl-imidazolium tetrafluoroborate, 1-methyl-imidazolium hexafluorophosphate, 1-methyl-imidazolium tetrafluoroborate, 1-methyl-imidazolium tosylate, 1-methyl-imidazolium trifluoromethanesulfonate, 1-octadecyl-3-methyl-imidazolium bis(trifluoromethylsulfonyl)imide, 1-octadecyl-3-methyl-imidazolium hexafluorophosphate, 1-octyl-1-methyl-pyrrolidinium bis(trifluoromethylsulfonyl)imide, 1-octyl-3-methyl-imidazolium bis(trifluoromethylsulfonyl)imide, 1-octyl-3-methyl-imidazolium bis(trifluoromethylsulfonyl)methane, 1-octyl-3-methyl-imidazolium hexafluoroantimonate, 1-octyl-3-methyl-imidazolium hexafluorophosphate, 1-octyl-3-methyl-imidazolium methylsulfate, 1-octyl-3-methyl-imidazolium tetrafluoroborate, 1-octyl-3-methyl-imidazolium trifluoromethanesulfonate, 1-pentyl-3-methyl-imidazolium trifluoromethanesulfonate, 1-pentyl-3-methyl-imidazolium tris(nonafluorobutyl)trifluorophosphate, 1-pentyl-3-methyl-imidazolium tris(pentafluoroethyl)trifluorophosphate, 1-phenylpropyl-3-methyl-imidazolium hexafluoroantimonate, 1-phenylpropyl-3-methyl-imidazolium hexafluorophosphate, 1-phenylpropyl-3-methyl-imidazolium tetrafluoroborate, 1-phenylpropyl-3-methyl-imidazolium trifluoromethanesulfonate, 1-tetradecyl-3-methyl-imidazolium tetrafluoroborate, 3-ethyl-N-butyl-pyridinium hexafluoroantimonate, 3-ethyl-N-butyl-pyridinium hexafluorophosphate, 3-ethyl-N-butyl-pyridinium tetrafluoroborate, 3-ethyl-N-butyl-pyridinium trifluoromethanesulfonate, 3-methyl-1-propyl-pyridinium bis(trifluormethylsulfonyl)imide, 3-methyl-N-butyl-pyridinium hexafluoroantimonate, 3-methyl-N-butyl-pyridinium hexafluorophosphate, 3-methyl-N-butyl-pyridinium methylsulfate, 3-methyl-N-butyl-pyridinium tetrafluoroborate, 3-methyl-N-butyl-pyridinium trifluoromethanesulfonate, 4-methyl-N-butyl-pyridinium hexafluorophosphate, 4-methyl-N-butyl-pyridinium tetrafluoroborate, benzyl triphenyl-phosphoniumbis(trifluoromethyl)imide, bis(trifluoromethylsulfonyl)imide, bis-tetramethyl ammonium oxalate, butyl dimethyl imidazolium hexafluorophosphate, butyl methyl imidazolium hexafluorophosphate, dimethyl diethyl ammonium hydroxide, dimethyl distearyl ammonium bisulfate, dimethyl distearyl ammonium methosulfate, ethyl triphenyl phosphonium acetate, guanidinium trifluoromethanesulfonate, guanidinium tris(pentafluoroethyl)trifluorophosphate, hexamethyl-guanidinium trifluoromethanesulfonate, hexamethyl-guanidinium tris(pentafluoroethyl)trifluorophosphate, methyl tributyl ammonium hydrogen sulfate, methyl triethyl ammonium hydroxide, methyl trioctyl ammonium bis(trifluoromethylsulfonyl)imide, N,N,N′,N′,N″-pentamethyl-N″-isopropyl-guanidinium trifluoromethanesulfonate, N,N,N′,N′,N″-pentamethyl-N″-isopropyl-guanidinium tris(pentafluoroethyl)trifluorophosphate, N,N,N′,N′,N″-pentamethyl-N″-propyl-guanidinium trifluoromethanesulfonate, N,N,N′,N′,N″-pentamethyl-N″-propyl-guanidinium tris(pentafluoroethyl)trifluorophosphate, N,N,N′,N′-tetramethyl-N″-ethyl-guanidinium trifluoromethanesulfonate, N,N,N′,N′-tetramethyl-N″-ethyl-guanidinium tris(pentafluoroethyl)trifluorophosphate, N-butyl-pyridinium bis(trifluoromethyl)imide, N-butyl-pyridinium hexafluoroantimonate, N-butyl-pyridinium hexafluorophosphate, N-butyl-pyridinium methylsulfate, N-butyl-pyridinium tetrafluoroborate, N-butyl-pyridinium trifluoromethanesulfonate, N-hexyl-pyridinium bis(trifluoromethylsulfonyl)imide, N-hexyl-pyridinium bis(trifluoromethylsulfonyl)methane, N-hexyl-pyridinium hexafluorophosphate, N-hexyl-pyridinium tetrafluoroborate, N-hexyl-pyridinium trifluoromethanesulfonate, N-octyl-pyridinium bis(trifluoromethylsulfonyl)imide, N-octyl-pyridinium tris(trifluoromethylsulfonyl)methane, O-ethyl-N,N,N′,N′-tetramethyl-isouronium trifluoromethanesulfonate, O-ethyl-N,N,N′,N′-tetramethyl-isouronium tris(pentafluoroethyl) trifluorophosphate, O-methyl-N,N,N′,N′-tetramethyl-isouronium trifluoromethanesulfonate, O-methyl-N,N,N′,N′-tetramethyl-isouronium tris(pentafluoroethyl)trifluorophosphate, S-ethyl-N,N,N′,N′-tetramethyl isothiouronium trifluoromethanesulfonate, S-ethyl-N,N,N′,N′-tetramethylisothiouronium tris(pentafluoroethyl)trifluorophosphate, S-ethyl-N,N,N′,N′-tetramethylthiouronium tetrafluoroborate, tetrabutyl ammonium bis(trifluoromethyl)imide, tetrabutyl ammonium bis(trifluoromethylsulfonyl)imide, tetrabutyl ammonium borohydride, tetrabutyl ammonium hexafluorophosphate, tetrabutyl ammonium hydrogen sulfate, tetrabutyl ammonium hydroxide, tetrabutyl ammonium nitrate, tetrabutyl ammonium perchlorate, tetrabutyl ammonium sulfate, tetrabutyl ammonium tetracyanoborate, tetrabutyl ammonium tetrafluoroborate, tetrabutyl ammonium tris(pentafluoroethyl)trifluorophosphate, tetrabutyl phosphonium acetate, tetrabutyl phosphonium bis(trifluoromethyl)imide, tetrabutyl phosphonium bis[1,2-benzenediolato(2-)-O,O′]-borate, tetrabutyl phosphonium bis[oxalato(2-)]-borate, tetrabutyl phosphonium hydroxide, tetrabutyl phosphonium tetracyanoborate, tetrabutyl phosphonium tris(pentafluoroethyl)trifluorophosphate, tetraethyl ammonium bis(trifluoromethyl)imide, tetraethyl ammonium bis(trifluoromethylsulfonyl)imide, tetraethyl ammonium bis[1,2-benzenediolato(2-)-O,O′]-borate, tetraethyl ammonium bis[2,2′-biphenyldiolato(2-)-O,O′]-borate, tetraethyl ammonium bis[malonato(2-)]-borate, tetraethyl ammonium bis[salicylato(2-)]-borate, tetraethyl ammonium hexafluorophosphate, tetraethyl ammonium hydrogen maleate, tetraethyl ammonium hydroxide, tetraethyl ammonium tetrafluoroborate, tetraethyl ammonium tosylate, tetraethyl ammonium tris(pentafluoroethyl)trifluorophosphate, tetramethyl ammonium bis(trifluoromethyl)imide, tetramethyl ammonium bis(trifluoromethylsulfonyl)imide, tetramethyl ammonium bis[oxalato(2-)]-borate, tetramethyl ammonium bis[salicylato(2-)]borate, tetramethyl ammonium hexafluorophosphate, tetramethyl ammonium hydrogenphthalate, tetramethyl ammonium hydroxide, tetramethyl ammonium tetrafluoroborate, tetramethyl ammonium tris(pentafluoroethyl)trifluorophosphate, tetrapropyl ammonium hydroxide, tributylethyl ammonium ethylsulfate, trihexyl(tetradecyl)-phosphonium bis(2,4,4-trimethylpentyl)phosphinate, trihexyl(tetradecyl)-phosphonium bis(trifluoromethylsulfonyl)imide, trihexyl(tetradecyl)-phosphonium bis(trifluoromethylsulfonyl)methane, trihexyl(tetradecyl)-phosphonium bis[1,2-benzenediolato(2-)-O,O′]-borate, trihexyl(tetradecyl)-phosphonium decanoate, trihexyl(tetradecyl)-phosphonium dicyanamide, trihexyl(tetradecyl)-phosphonium hexafluorophosphate, trihexyl(tetradecyl)-phosphonium tetracyanoborate, trihexyl(tetradecyl)-phosphonium tetrafluoroborate, trihexyl(tetradecyl)-phosphonium, tris(pentafluoroethyl)trifluorophosphate, and tri-iso-butyl(methyl)-phosphonium tosylate, and combinations thereof. Halide salts (e.g., fluoride, chloride, bromide, and iodide salts) of the above-noted electrolytes are also suitable for use in the invention.

Preferably, the electrode microarray has at least 10 electrodes. In one embodiment, the electrode microarray has about 1000 electrodes. In one embodiment, the electrode microarray has about 12,000 electrodes. In one embodiment, the electrode microarray has about 90,000 electrodes. In one embodiment, the electrode microarray has about 1,000,000 electrodes.

In one embodiment, the method disclosed herein is performed on a surface substantially parallel to the surface of the electrode microarray, wherein the porous layer is attached to the opposing surface where the electrochemical reactions occur thereto.

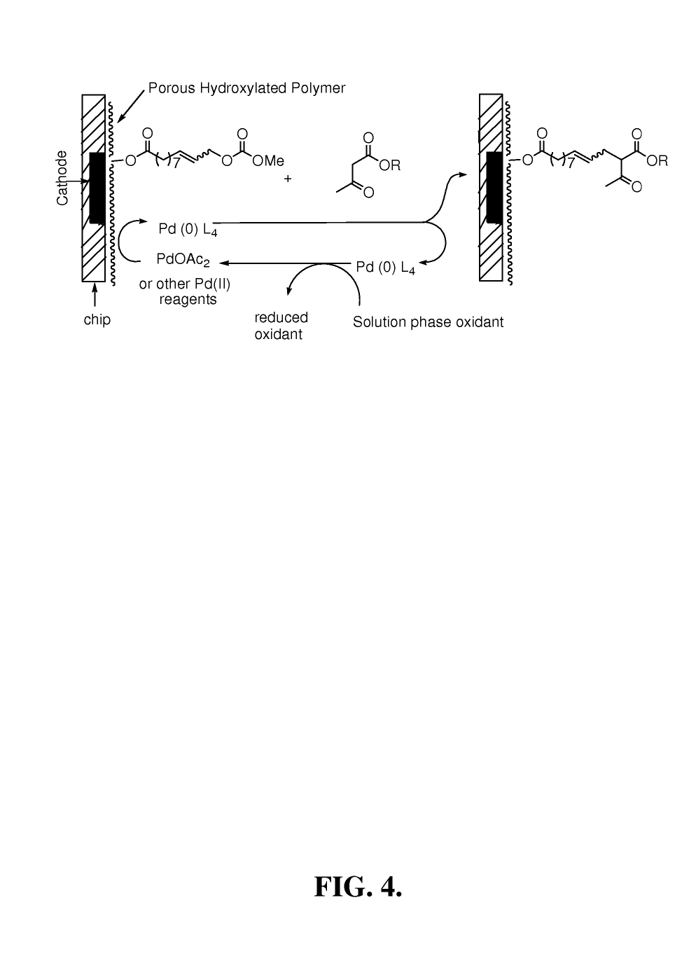

The transition metal-catalyzed catalyzed allylic alkylation reaction of the method provides an effective means for site-selectively coupling a nucleophile to an allylic substrate immobilized on the surface of an electrode (e.g., a microelectrode). FIG. 4 illustrates a palladium (0) catalyzed allylic alkylation site-selectively preformed at a specific location on an addressable microelectrode array. Referring to FIG. 4, an allylic substrate is attached to the electrode's coating material. The transition metal catalyst in its active state (Pd(0)) is generated in the vicinity of the electrode. The coupling between the allylic substrate and the nucleophile is catalyzed by the active state transition metal catalyst. The confining agent converts the transition metal catalyst from its active state (Pd(0)) to its oxidized inactive state (Pd(II)) and thereby confines the active state transition metal catalyst to the vicinity of the electrode selected for use as cathode. In this way, the confining agent is used to isolate the allylic alkylation reaction to the selected electrode in the electrode array.

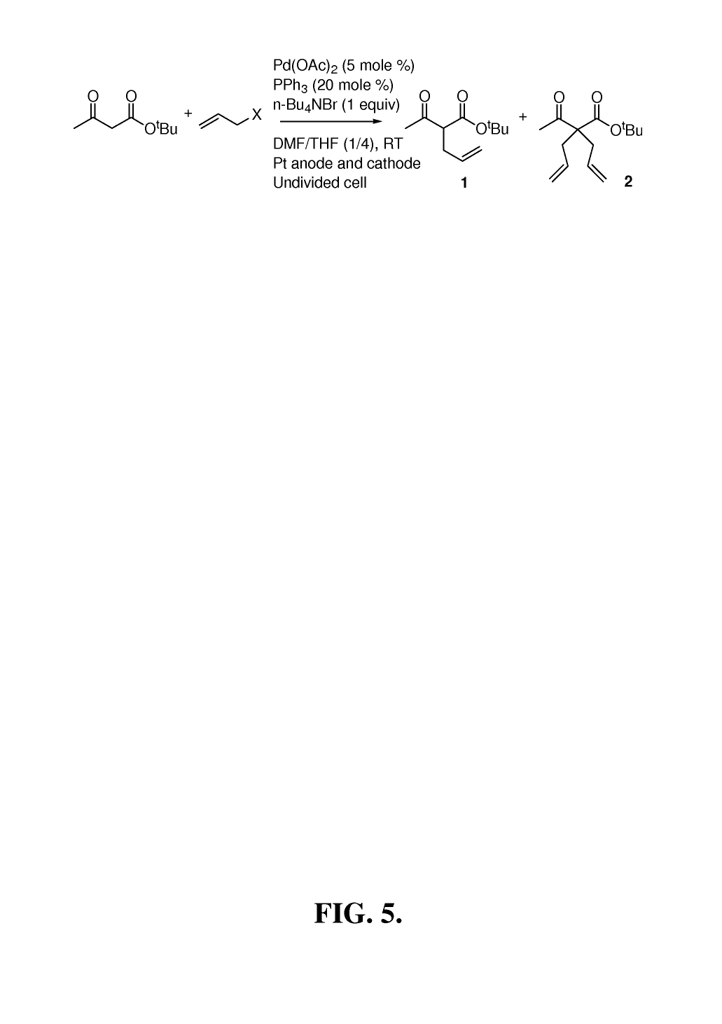

Solution phase allylic alkylation reactions of t-butyl acetoacetate with allyl bromide (X═Br), allyl acetate (X═OAc), and allyl carbonate (X═OC(O)OR) as the allylic substrates are illustrated in FIG. 5. Referring to FIG. 5, the three reactions were examined using palladium as the transition metal catalyst and triphenyl phosphine as the stabilizer. The results for passing a current through the reaction solution are compared in Table 1.

TABLE 1
Comparison of the Solution Phase Allylic Alkylation
of T-Butyl Acetoacetate With Allyl Halide, Allyl
Acetate, and Allyl Carbonate, Respectively.

| | | DBU | Time | Electricity | % Yield |
|---|---|---|---|---|---|
| Entry | X | (equiv) | (h) | (F/mole) | (1 + 2/2:1) |
| 1a | Br | 1 | 24 | none | 72 |
| 1b | Br | 1 | 3 | 3.0 | 75 |
| 2a | OAc | 1 | 24 | none | 78 |
| 2b | OAC | 1 | 4 | 2.9 | 79 |
| 3a | OCO2Me | 0 | 6 | none | 81 |
| 3b | OCO2Me | 0 | 2 | 1.6 | 82 |

achemical
belectrochemical

In each allylic alkylation reaction, t-butyl acetoacetate was mixed with an allylic substrate (i.e., electrophile) in the presence of palladium (II) diacetate (Pd(OAc)₂), triphenylphosphine, and tetrabutylammonium bromide in a DMF/THF solution. For reactions utilizing either allyl bromide substrate or allyl acetate substrate, 1,8-diazabicyclo[5.4.0]undec-7-ene (DBU) was added. No additional base was necessary for reactions with allyl carbonate.

For the electrochemical reactions, two platinum electrodes were added to the solution containing the reactants and a constant current of 20 mA was passed through the solution. For each substrate, the passage of current through the reaction accelerated the reaction.

Yields for both electrochemical and non-electrochemical reactions were comparable. The largest rate acceleration occurred with the use of the allyl bromide substrate, in which passing current through the reaction led to an 8-fold rate acceleration. For reactions using the allyl carbonate substrate, a 3-fold increase in rate was observed.

Not wanting to be limited by the theory, it is believed that the current being passed through the reaction cell accelerated the reactions by breaking up palladium clusters that are known to form inactive precipitates. This might be accomplished by the oxidation of Pd(0) to Pd(II) at the anode. Re-reduction of the Pd(II) at the cathode would then regenerate a catalytically active Pd(0) species, thereby insuring a steady state of active catalyst in the reaction.

Each solution phase allylic alkylation reaction described above formed both mono- and di-alkylated product in a 2:1 ratio. The passage of current through the reaction cell did not alter this ratio. Because a large excess of the nucleophile is used in the microelectrode array-based reactions, it is believed that the formation of the monosubstituted product would be favored in the allylic alkylation reaction selectively carried out on one or more electrodes of an array in accordance with the method of the invention.

Electrochemically-assisted allylic alkylation reactions were carried out for microelectrode array reactions as shown in FIG. 4. The allylic substrates for these reactions were immobilized on the electrodes of the electrode array through the use of an azobenzene reduction. Quinone was used as the oxidant for confining the active state palladium catalyst Pd(0) to the vicinity of the selected electrodes.

In a further aspect of the invention, a process for attaching an allylation substrate proximally to a plurality of electrodes is provided. In one embodiment, the method includes

(a) contacting an electrode array device with an organic solution comprising an allylation substrate, a base, and an electrolyte, wherein the electrode array device comprises a plurality of individually addressable electrodes, each having a porous reaction layer proximal thereto, wherein the porous reaction layer has reactive hydroxyl groups; and

(b) selectively biasing one or more of the electrodes with a voltage or current to provide a reduced base, wherein the reduced base triggers a based-catalyzed esterification reaction between the porous reaction layer and the allylation substrate, whereby the allylation substrate attaches to the porous reaction layer.

In one embodiment, the porous reaction layer comprises agarose. In one embodiment, the base is azobenzene. In one embodiment, the electrolyte is tetrabutylammonium bromide.

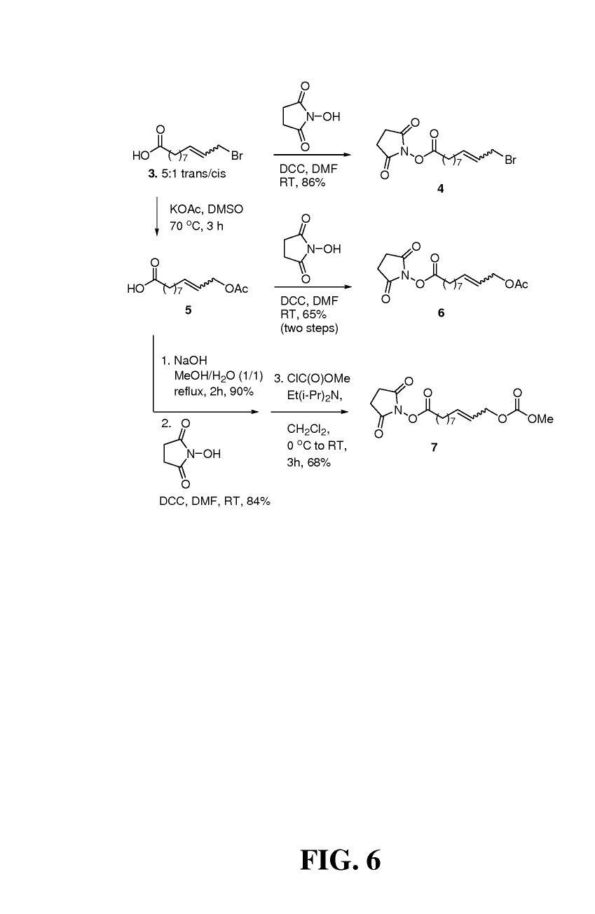

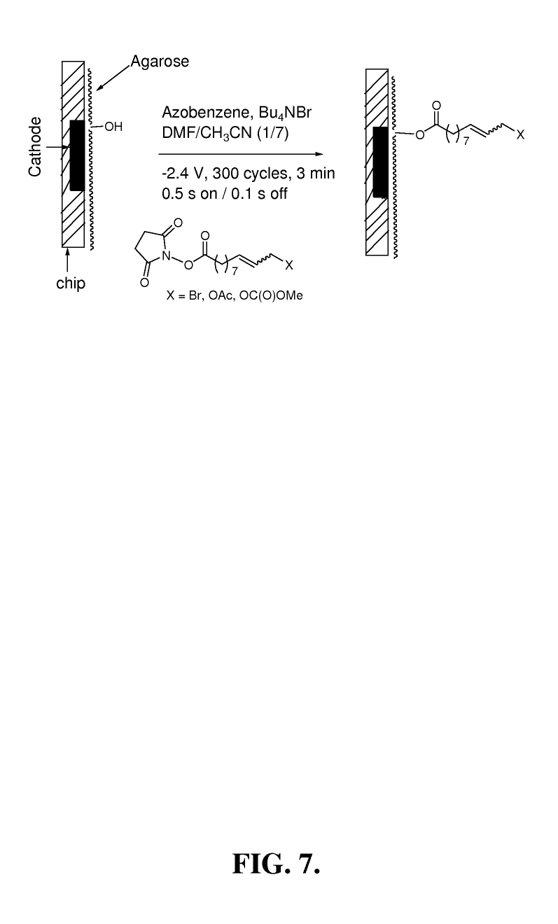

In one embodiment, the allylation substrate is an N-hydroxysuccinimide ester. Representative N-hydroxysuccinimide esters include allyl bromide N-hydroxysuccinimides, allyl acetate N-hydroxysuccinimides, and allyl carbonate N-hydroxysuccinimides. Allylic compounds used for immobilizing the allylic substrates on the electrodes were synthesized as illustrated in FIG. 6 and described in Example 3. Three allylic N-hydroxysuccinimide esters were prepared using allyl bromide as the starting material. For each, the N-hydroxysuccinimide ester was formed by esterification of the carboxylic acid group with the N-hydroxysuccinimide hydroxy group. The N-hydroxysuccinimide esters were then used to prepare the immobilized allylic substrates proximal to the microelectrodes in an addressable array as shown in FIG. 7.

The allylic N-hydroxysuccinimide esters were attached to the electrodes' agarose polymer coating as illustrated in FIG. 7. The electrodes of the microelectrode array were coated with agarose and then treated with a solution of the N-hydroxysuccinimide ester, azobenzene, and tetrabutylammonium bromide in a 1:7 mixture of DMF and acetonitrile. The selected microelectrodes in the array were then used as cathodes (0.5 s on/0.1 s off for 300 cycles) in order to reduce the azobenzene and trigger a base-catalyzed esterification reaction between the agarose polymer and the N-hydroxysuccinimide ester. In this manner, the allylic compounds were attached to the agarose polymer proximal to the microelectrodes in the array to provide immobilized allylic substrates.

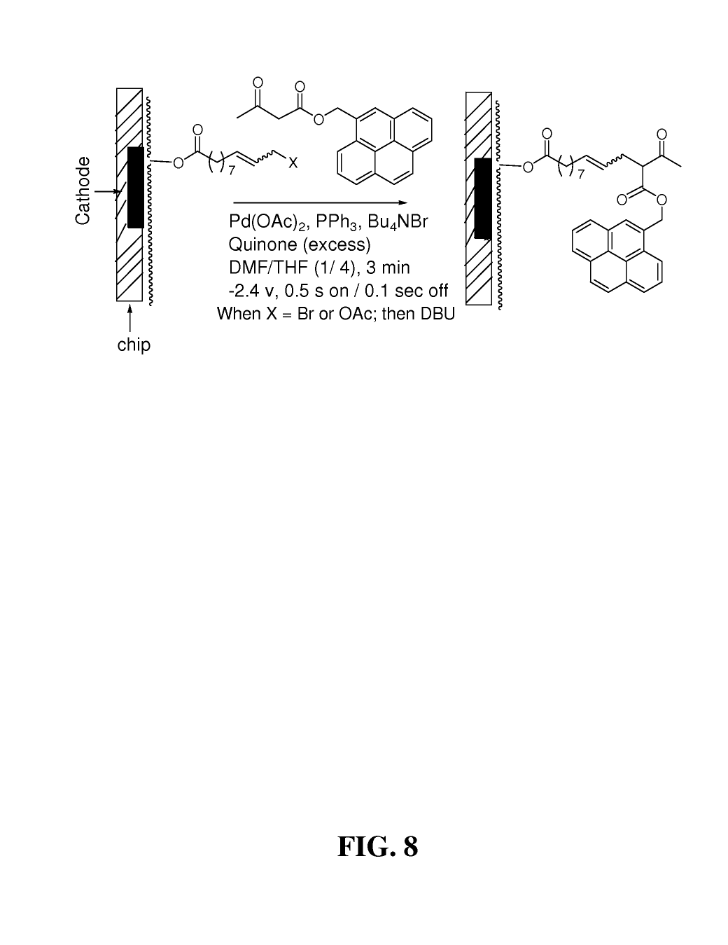

Representative palladium-catalyzed allylic alkylation reaction was conducted in a fashion nearly identical to the solution phase reactions described above and as illustrated in FIG. 8. The microelectrode array was treated with a 1:4 DMF:THF solution containing palladium (II) diacetate, an acetoacetate nucleophile, triphenylphosphine, and tetrabutylammonium bromide. The base, 1,8-diazabicyclo[5.4.0]undec-7-ene (DBU), was added into the solution when the allyl bromide or allyl acetate substrates were used. No additional base was added when the allyl methyl carbonate substrate was used. The acetoacetate nucleophile employed was functionalized with a pyrene group for use in subsequent fluorescence studies to determine the success of the reaction.

Selected microelectrodes in a checkerboard pattern in the array were then used as cathodes for the reduction of palladium (II) diacetate and the generation of the active Pd(0) catalyst. A remote platinum wire was used as the auxiliary anode for the electrolysis. Different from the earlier solution phase electrolysis, an excess amount of a confining agent, quinone, was added to prevent migration of the Pd(0) catalyst generated at the selected electrodes to remote sites on the array.

For the microelectrode array reactions, the selected electrodes were cycled. Each selected cathode was turned on for a period of 0.5 s and then turned off for 0.1 s. Microelectrodes that were not selected were left off for the entire time. After 300 cycles, the microelectrode array was removed from the solution, washed, and then examined with the use of a fluorescence microscope.

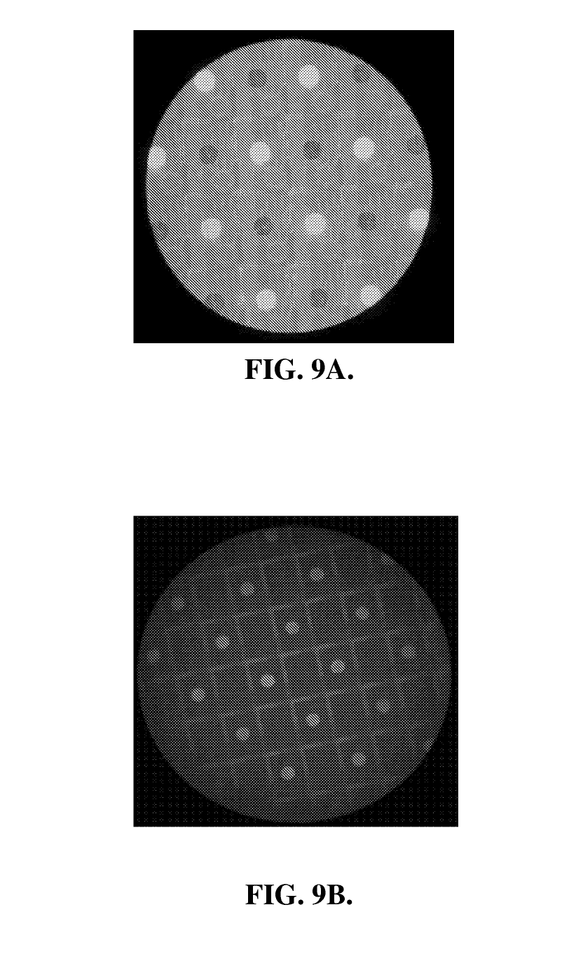

Selective allylic alkylation reactions with the three allylic substrates were accomplished and confinement across the microelectrode array was maintained. As shown in FIGS. 9A and 9B, the use of allyl acetate and allyl carbonate substrates led to clear confinement of the reaction to the selected electrodes. In FIG. 9A, the lighter spots illustrate the reaction with the allyl acetate substrate at selected electrodes. In FIG. 9B, the lighter spots illustrate the reaction with the allyl carbonate substrate at selected electrodes. The difference in the images results from the emission of the pyrene (λ max=345 nm) matching closely with the blue light used (360 nm for excitation). The fluorescence observed with the red light is due to a long-lived component of the pyrene eximer emission (λ max=480 nm) that does not match as closely with the light source used (560 nm for excitation). Hence, with the blue light the intensity of the light used does not have to be as high. This reduces the background fluorescence from the chip and preserves more of the fine details associated with the chip itself.

In another aspect, the invention provides a microarray having a plurality of allylation substrates attached thereto. In one embodiment, the microarray includes:

(a) a substrate having a plurality of known locations;

(b) a porous reaction layer attached to the substrate and covering the known locations; and

(c) a plurality of allylation substrates attached to the porous reaction layer at the known locations.

### EXAMPLES

### Example 1

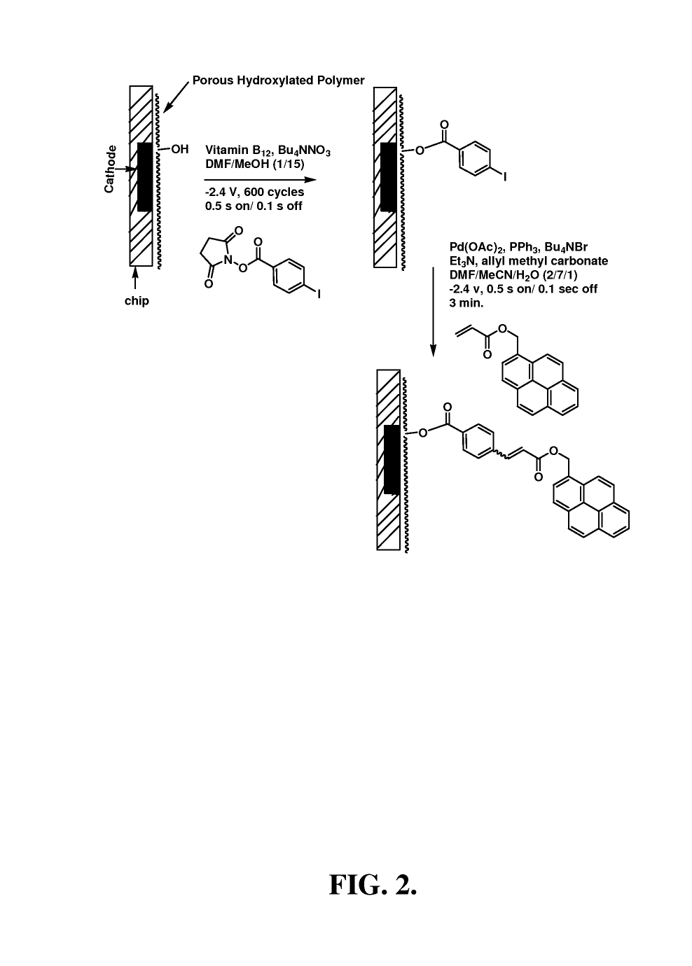

This example tested the feasibility of the inventive process. The experiment outlined in FIG. 2 was performed. First, an aryl iodide was placed on the surface of an electrode array device (Combimatrix Corporation, Mukilteo, Wash.) coated with polysaccharide, and then the electrode array device was submerged in an electrolyte solution containing 1-pyrenemethyl acrylate, palladium acetate, triphenylphoshine ligand, and allyl methyl carbonate. Selected cathodes were used to reduce the palladium acetate to the desired Pd(0) catalyst. If there was successful reduction, the Pd(0) catalyst generate would trigger a Heck reaction between the surface-bound aryl iodide the 1-pyrenemethyl acrylate, but only at those electrode sites whose electrodes were activated as a cathode. A successful Heck reaction would place the fluorescent pyrene moiety onto the surface of the electrode array device, but only in the region surrounding an electrode. This creates the ability to monitor the success of the reaction.

Following the reaction, the active Pd(0) catalyst was scavenged by the allyl methyl carbonate in order to generate a Pd(II) π-allyl complex and stop the catalytic process. Reformation of the Pd(0) catalyst at either a selected electrode site or another selected electrode site would require either reduction of more of the Pd(OAc)₂ reagent or reduction of the π-allyl Pd(II) complex (Hayakawa et al., Nucleosides Nucleotides, 17:441, 1988). By balancing the rate at which the Pd(II) is reduced at the selected electrodes with the concentration of the allyl methyl carbonate in solution, the Heck reaction was confined to just the regions surrounding the selected electrodes (that is, the ones acting as cathodes).

### Example 2

A series of solution phase Heck reactions were performed in order to determine reaction conditions that would allow for an electrochemically generated Heck reaction. Two key discoveries were made along these lines. First, a Heck reaction between methyl 4-iodobenzoate and 1-pyrenemethyl acrylate proceeded slowly (18 h/82% yield) with Pd(OAc)₂ in a 9:1 DMF:H₂O solution containing triethylamine and tetrabutylammonium bromide while the same reaction proceeded to completion in just 3 h when a cathode was inserted and the Pd(OAc)₂ reduced electrochemically. Second, the Heck reaction did not proceed at all (0% after 18 h) in the absence of the cathode when the DMF solvent was exchanged for acetonitrile. The corresponding electrochemical reaction proceeded to completion (76% yield) in 12 hours. Hence, using acetonitrile as the solvent for the reactions would assure that the Heck reaction would not spontaneously occur at sites on the electrode array device without a working cathode. Even if the more efficient DMF reaction conditions were eventually needed on the electrode array device, it appeared that the non-electrochemical background reaction was slow enough to be negligible, especially since on the electrode array device, a high concentration of the catalyst was generated at the electrodes directly next to the selected substrates.

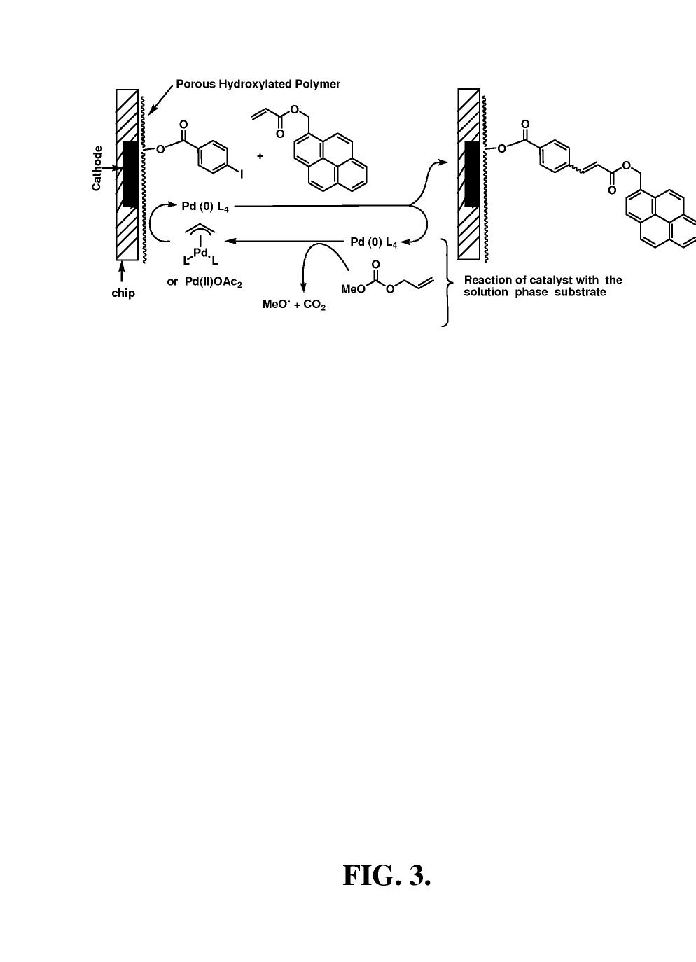

Electrode array device-based experiments were initiated by depositing aryl iodide onto the electrode array device using the same methodology employed in the earlier Wacker oxidation experiment (FIG. 3) (Tesfu et al., J. Am. Chem. Soc. 126:6212, 2004). To this end, all of the electrodes on the electrode array device were utilized as cathodes in order to reduce vitamin B₁₂. This effectively generated a base. The base served to catalyze an esterification reaction between the hydroxyl groups of the polysaccharide polymer coating the electrode array device and the N-hydroxysuccinimide ester of 4-iodobenzoic acid. The effect of this process was to concentrate the aryl iodide substrate near the electrodes on the electrode array device.

The Heck reaction was then performed by submerging the electrode array device in a 2:7:1 DMF/MeCN/H₂O solution containing Pd(OAc)₂, triphenyl-phosphine, triethylamine, allyl methyl carbonate, and tetrabutyl-ammonium bromide electrolyte. Selected electrodes were turned on as cathodes at a voltage of −2.4 V (relative to a Pt auxiliary electrode as an anode) in order to generate a box pattern of electrodes on the array with a dot in the center. The electrodes (Pt surface) were cycled for 0.5 sec on and then 0.1 sec off for 3 min.

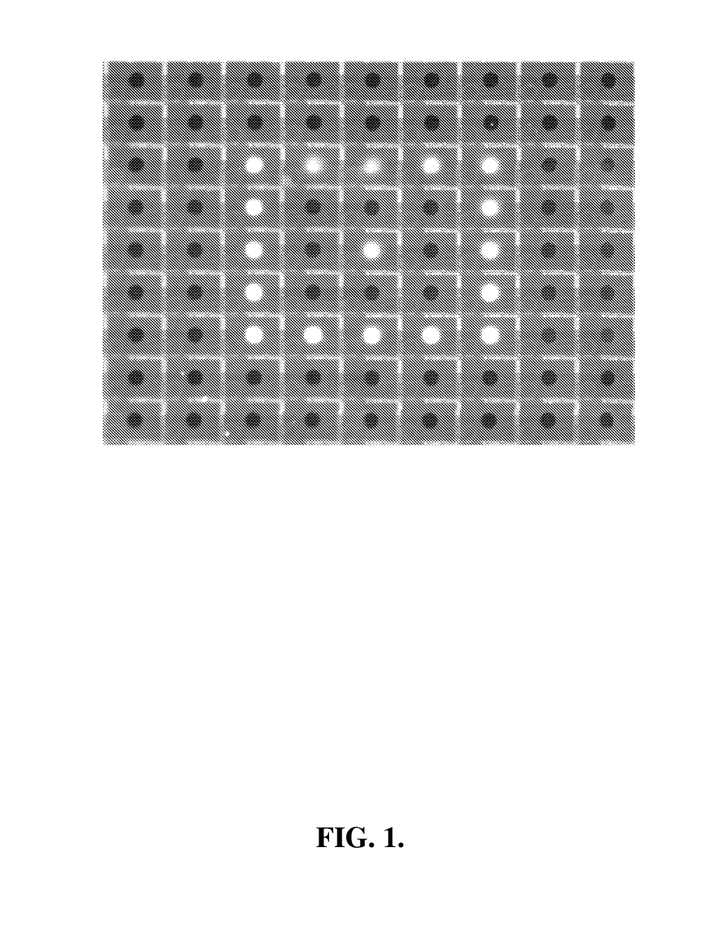

Following the reaction, the electrode array device was washed with hexane to remove any unreacted pyrene containing substrate and then the electrode array device imaged using a fluorescent microscope. The result is shown in FIG. 1. FIG. 1 shows an expanded view of 81 of the 1028 electrodes on the electrode array device. The bright spots in the figure are formed by pyrene on the electrode array device's surface and coincide perfectly with the selected or activated electrodes. The dark spots are electrodes that were not activated and block the background fluorescence of the electrode array device. Therefore, the confining or scavenging agent worked well and the Heck reaction was restricted to only the selected electrode regions.

### Example 3

### The Synthesis of Allylic N-Hydroxysuccinimide Esters Useful for Preparing Representative Immobilized Allylic Substrates

The syntheses of allylic N-hydroxysuccinimide (NHS) esters useful for preparing representative immobilized allylic substrates are illustrated schematically in FIG. 6 and described below.

Allyl bromide NHS Ester 4. Allyl bromide carboxylic acid 3 was mixed with N-hydroxysuccinimide in a solution of DMF and dicyclohexylcarbodiimide (DCC). The reaction mixture was stirred at room temperature. The allyl bromide N-hydroxysuccinimide ester 4 was obtained in a yield of 86%.

### (E/Z)-10-Bromo-9-undecylenic acid

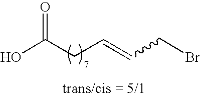

To a solution of 10-undecylenic acid (5.9 g, 50 mmol) and N-bromosuccinimide (7.1 g, 40 mmol) in anhydrous carbon tetrachloride (100 mL) was added AIBN (2,2′-azobisisobutyronitrile, 98.4 mg, 0.6 mmol). After refluxing for 1.5 h, the reaction mixture was cooled to room temperature and filtrated to remove insoluble succinimide. The filtrate was evaporated under reduced pressure and purified by silica gel column chromatography (hexane/ethyl acetate 8/1) to afford an inseparable mixture (E/Z)-10-bromo-9-undecylenic acid in 70% yield as colorless oil; IR (neat) ν cm⁻¹; ¹H NMR (CDCl₃) δ 5.60-5.80 (m, 2H), 4.00 (d, J=6.3 Hz, 0.32H), 3.96 (d, J=6.3 Hz, 1.68H), 2.36 (t, J=7.2 Hz, 2H), 2.00-2.12 (m, 2H), 1.60-1.70 (m, 2H), 1.22-1.45 (m, 8H).

### (E/Z)-10-Bromo-9-undecylenic acid N-hydroxysuccinimide ester

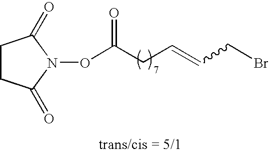

To a solution of (E/Z)-10-bromo-9-undecylenic acid (1.05 g, 4 mmol) and N-hydroxysuccinimide (575.5 mg, 5 mmol) in anhydrous DMF (10 mL) was added DCC (1,3-dicyclohexylcarbodiimide, 1.24 g, 6 mmol). After stirring for 12 h, the reaction mixture was filtrated to remove insoluble 1,3-dicyclohexylurea. The filtrate was added equal amount of water and was then extracted with dichloromethane. The dichloromethane layer was successively washed with water and brine, and then dried over Na₂SO₄. After evaporating under reduced pressure, the residue was purified by silica gel column chromatography (hexane/dichloromethane/ethyl acetate 5/5/1) to afford an inseparable mixture (E/Z)-10-bromo-9-undecylenic acid N-hydroxysuccinimide ester in 86% yield as colorless solid; IR (neat) ν 2935, 2860, 2226, 1747, 1714, 1373, 1257, 1008 cm⁻¹; ¹H NMR (CDCl₃) δ 5.60-5.80 (m, 2H), 4.00 (d, J=6.3 Hz, 0.32H), 3.96 (d, J=6.3 Hz, 1.68H), 2.82 (s, 4H), 2.60 (t, J=7.2 Hz, 2H), 2.00-2.16 (m, 2H), 1.65-1.78 (m, 2H), 1.22-1.45 (m, 8H). ¹³C NMR (CDCl₃) δ; HRMS (FAB) calcd. for C₁₅H₂₂BrNO₄ (382.0630) [M+Na]⁺. found 382.0645 [M+Na]⁺.

Allyl acetate NHS Ester 6. Allyl bromide carboxylic acid 3 was heated with KOAc in DMSO at 70° C. for 3 hours to yield allyl acetate carboxylic acid 5. Compound 5 was mixed with N-hydroxysuccinimide in a solution of DMF and DCC. The reaction mixture was stirred at room temperature. Allyl acetate N-hydroxysuccinimide ester 6 was obtained in a yield of 65%.

### (E/Z)-10-Acetyl-9-undecylenic acid N-hydroxysuccinimide ester

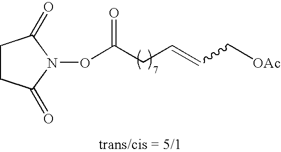

To a solution of (E/Z)-10-bromo-9-undecylenic acid (5.26 g, 20 mmol) in anhydrous DMSO (50 mL) was added KOAc (9.8 g, 0.1 mol). After stirring at 70° C. for 4 h, the reaction mixture was filtrated to remove unreacted KOAc. The filtrate was neutralized with 1M HCl, extracted with diethyl ether (25 mL×3), washed with brine, and dried over Na₂SO₄. The diethyl ether extract was evaporated under reduced pressure to give crude (E/Z)-10-acetyl-9-undecylenic acid, which was used for next step without further purification. To a solution of crude (E/Z)-10-acetyl-9-undecylenic acid (0.97 g, 4 mmol) and N-hydroxysuccinimide (575.5 mg, 5 mmol) in anhydrous DMF (10 mL), was added DCC (1.24 g, 6 mmol). After stirring for 12 h, the reaction mixture was filtrated to remove insoluble 1,3-dicyclohexylurea. The filtrate was added equal amount of water and was then extracted with dichloromethane. The dichloromethane layer was successively washed with water and brine, and then dried over Na₂SO₄. After evaporating under reduced pressure, the residue was purified by silica gel column chromatography (hexane/dichloromethane/ethyl acetate 5/5/1) to afford an inseparable mixture (E/Z)-10-acetyl-9-undecylenic acid N-hydroxysuccinimide ester in 65% yield (two steps) as colorless solid. The mixture was contaminated with a small amount of the S_{N}2′-product. IR (neat) ν cm⁻¹; ¹H NMR (CDCl₃) δ 5.67-5.78 (m, 1H), 5.46-5.57 (m, 1H), 4.58 (d, J=6.3 Hz, 0.32H), 4.47 (d, J=6.3 Hz, 1.68H), 2.81 (s, 4H), 2.57 (t, J=7.5 Hz, 2H), 2.02 (s, 3H), 1.98-2.12 (m, 2H), 1.66-1.75 (m, 2H), 1.22-1.40 (m, 8H); ¹³C NMR (CDCl₃) (trans) δ 169.8, 169.4, 168.8, 136.6, 124.0, 65.5, 32.4, 31.1, 29.0, 28.9, 28.8, 25.8, 24.7, 21.2; HRMS (FAB) calcd. for C₁₇H₂₅NO₆ (362.1580) [M+Na]⁺. found 362.1580 [M+Na]⁺.

Allyl carbonate NHS Ester 7. Allyl acetate carboxylic acid 5 was refluxed for 2 hours with NaOH in MeOH/H₂O (1:1) to yield an allyl hydroxy carboxylic acid as the hydrolysis product. The allyl hydroxy carboxylic acid was then mixed with N-hydroxysuccinimide in a solution of DMF and DCC. The reaction mixture was stirred at the room temperature to afford an allyl hydroxy N-hydroxysuccinimide ester in a yield of 84%. The allyl hydroxy N-hydroxysuccinimide ester was treated with methyl chloroformate using diisopropyl ethyl amine in a methylene chloride solution. The mixture was warmed from 0° C. to the room temperature in 3 hours. Allyl carbonate N-hydroxysuccinimide ester 7 was obtained in a yield of 68%.

### (E/Z)-10-hydroxy-9-undecylenic acid

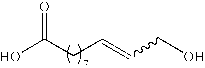

To a solution of (E/Z)-10-acetyl-9-undecylenic acid (2.42 g, 10 mmol) in MeOH—H₂O (4/1, 50 mL) was added NaOH (1.6 g, 40 mol). After refluxing for 2 h, the reaction mixture was cooled to room temperature and neutralized with 1 M HCl. The resulting solution was concentrated under reduced pressure and chromatographed over silica gel (hexane/acetone 5/1) to afford an inseparable mixture (E/Z)-10-hydroxy-9-undecylenic acid in 90% yield as colorless oil. ¹H NMR (CDCl₃) δ 6.50 (brs, —CO₂H), 5.50-5.70 (m, 2H), 4.18 (d, J=6.0 Hz, 0.32H), 4.07 (d, J=6.0 Hz, 1.68H), 2.57 (t, J=7.5 Hz, 2H), 2.02 (s, 3H), 1.97-2.05 (m, 2H), 1.59-1.64 (m, 2H), 1.29-1.38 (m, 8H).

### (E/Z)-10-Hydroxy-9-undecylenic acid N-hydroxysuccinimide ester

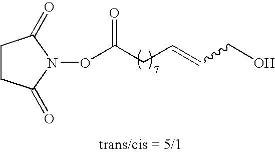

To a solution of (E/Z)-10-hydroxy-9-undecylenic acid (0.8 g, 4 mmol) and N-hydroxysuccinimide (0.69 g, 6 mmol) in anhydrous DMF (10 mL) was added DCC (1,3-dicyclohexylcarbodiimide, 1.24 g, 6 mmol). After stirring for 12 h, the reaction mixture was filtrated to remove insoluble 1,3-dicyclohexylurea. The filtrate was added equal amount of water and was then extracted with dichloromethane. The dichloromethane layer was successively washed with water, brine and dried over Na₂SO₄. After evaporating under reduced pressure, the residue was purified by silica gel column chromatography (dichloromethane/acetone 20/1) to afford an inseparable mixture (E/Z)-11-hydroxy-9-undecylenic acid N-hydroxysuccinimide ester in 84% yield as colorless solid. The material was carried on without further purification.

### (E/Z)-10-Methoxycarboxy-9-undecylenic acid N-hydroxysuccinimide ester

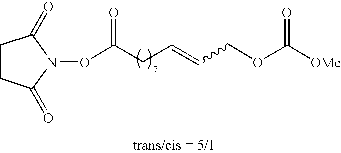

To a solution of (E/Z)-10-hydroxy-9-undecylenic acid N-hydroxysuccinimide ester (892.0 mg, 3 mmol) and N,N-diisopropylethylamine (2.1 mL, 12 mmol) in anhydrous dichloromethane (10 mL) at 0° C. was slowly added methyl chloroformate (0.3 mL, 6 mol). The reaction mixture was gradually warmed up to room temperature and then stirred for 3 h. The resulting suspension was concentrated under reduced pressure and chromatographed over silica gel (hexane/dichloromethane/ethyl acetate 5/5/1) to afford an inseparable mixture (E/Z)-10-methoxycarboxy-9-undecylenic acid N-hydroxysuccinimide ester in 68% yield as colorless solid. IR (neat) ν cm⁻¹; ¹H NMR (CDCl₃) δ 5.57-5.81 (m, 1H), 5.46-5.57 (m, 1H), 4.62 (d, J=6.9 Hz, 0.32H), 4.52 (d, J=6.9 Hz, 1.68H), 3.94 (s, 0.48H), 3.72 (s, 2.52H), 2.80 (s, 4H), 1.97-2.04 (m, 2H), 1.64-1.71 (m, 2H), 1.27-1.36 (m, 8H); ¹³C NMR (CDCl₃) (trans) δ 169.4, 168.8, 155.8, 137.5, 123.5, 68.8, 54.8, 32.3, 31.1, 29.0, 28.9, 28.8, 25.8, 24.7; HRMS (FAB) calcd. for C₁₇H₂₅NO₇ (378.1529) [M+Na]⁺. found 378.1529 [M+Na]⁺;

### 1-Pyrenemethyl acetoacetate

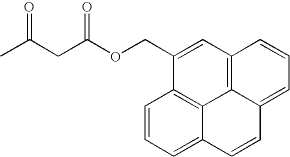

To a solution of 1-pyrenemethanol (2.32 g, 10 mmol) and 4-DMAP (122.2 mg, 1 mmol) in anhydrous toluene (30 mL), was added tert-butylacetoacetate (5.0 mL, 30 mol). After refluxing for 5 h, the reaction mixture was cooled to room temperature and neutralized with 1 M HCl. The toluene solution was concentrated under reduced pressure and chromatographed over silica gel (hexane/ethyl acetate 6/1) to afford 1-pyrenemethyl acetoacetate in 86% yield as a yellow solid. IR (neat) ν cm⁻¹; ¹H NMR (CDCl₃) δ 8.00-8.28 (m, 9H), 5.90 (s, 2H), 3.53 (s, 2H), 2.21 (s, 3H); ¹³C NMR (CDCl₃) δ 14.1, 23.5, 24.3, 28.8, 28.9, 29.9, 33.4, 43.5, 64.5, 75.8, 100.9, 116.4, 151.2, 154.1, 209.0; HRMS (FAB) calcd. for C₂₁H₁₆NO₃ (339.0997) [M+Na]⁺. found 339.0992 [M+Na]⁺.

### Example 4

### Representative Procedures for Microelectrode Array-Based Allylation Reactions

Representative procedures for microelectrode array-based allylation reactions in accordance with the present invention are illustrated schematically in FIGS. 7 and 8 and described below.

### General Procedure for Microelectrode-Array Based Allylation Reactions

Substrate Loading onto the Microelectrode Array: To a 1.7 mL eppendorf tube, 32.2 mg tetrabutylammonium bromide, a DMF solution (100 μL) of succinimidyl substrate (1.4 mg), a DMF solution (100 μL) of azobenzene (1.5 mg), and 1.4 mL of acetonitrile were added, respectively. The mixed solution was vortexed for a few seconds and then the chip was inserted into this solution. The electrodes on the chip were turned on as cathodes using a potential drop between the electrodes in the microarray and a remote Pt wire of −2.4 volts. The microelectrodes were cycled on for 0.5 sec and off for 0.1 sec for a total of 300 cycles. The microelectrode array was then washed several times with ethanol and then used for the allylic alkylation reaction below.

Microelectrode Array-Based Allylation Reactions: Into a 1.7 mL eppendorf tube was added 3.2 mg of Pd(OAc)₂ in 0.1 mL of DMF, 1.0 mg of PPh₃ in 0.1 mL of DMF, 3.2 mg of 1-pyrenemethyl acetoacetate in 0.1 mL of DMF, 32.2 mg of Bu₄NBr, 5.4 mg of quinine, and 1.2 mL of THF. The chip loaded above with the allylic substrate was submerged in this mixed solution and then selected cathodes were pulsed at a voltage of −2.4 V for 0.5 sec on and 0.1 sec off. After 3 minutes, the chip was repeatedly washed with EtOH and then imaged using a fluorescence microscope.

### General Chemical Procedure for the Allylic Alkylation of tert-Butyl Acetoacetate with Either Allylbromide or Allylacetate

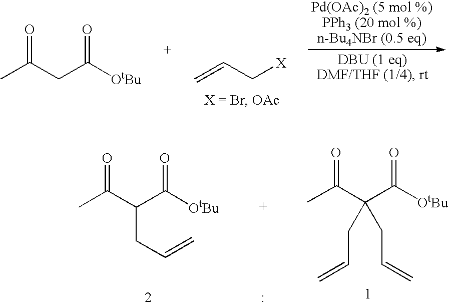

To a 50 mL round bottom flask with a mixture of allyl bromide or allyl acetate (2.0 mmol), tert-butyl acetoacetate (2.4 mmol), Pd(OAc)₂ (22.4 mg, 0.1 mmol), PPh₃ (104.9 mg, 0.4 mmol) and tetrabutylammonium bromide (322.4 mg, 1.0 mmol) was added a solution of 2 mL of DMF, 8 mL of THF and 0.3 mL of 1,8-diazabicyclo[5,4,0]undec-7-ene (DBU, 2.0 mmol). The resulting brown solution was stirred for 24 h at room temperature under an argon atmosphere. 1 M HCl was then added to the reaction mixture until pH<5. The resulting suspension was extracted with CH₂Cl₂ (3×20 mL). The combined organic layer was first washed with water and brine, and then poured into a short pad column with silica gel eluting with CH₂Cl₂. The CH₂Cl₂ elute was concentrated under reduced pressure. The residue was further subjected to column chromatography eluting with hexane/ethyl acetate (20/1) to yield mono- and di-allylated products in a ratio of 2/1.

tert-Butyl 2-allylacetoacetate: Colorless oil; ¹H NMR (300 MHz, CDCl₃) δ 5.63-5.76 (m, 1H), 5.06 (dd, J=16.5, 1.8 Hz, 1H), 4.99 (dd, J=10.2, 1.8 Hz, 1H), 3.39 (t, J=7.2 Hz, 1H), 2.51 (t, J=7.2 Hz, 2H), 2.19 (s, 3H), 1.43 (s, 9H); ¹³C NMR (75 MHz, CDCl₃) δ 168.6, 134.7, 117.3, 82.2, 60.4, 32.3, 29.1, 28.1. Reference: Zhang, Y.; Raines, A. J.; Flowers, R. A. II. J. Org. Chem. 2004, 69, 6267.

tert-Butyl 2,2′-diallylacetoacetate: Colorless oil; ¹H NMR (300 MHz, CDCl₃) δ 5.63-5.76 (m, 1H), 5.10 (dd, J=10.8, 1.8 Hz, 1H), 5.06 (dd, J=16.5, 1.8 Hz, 1H), 2.54 (t, J=6.9 Hz, 2H), 2.10 (s, 3H), 1.42 (s, 9H); ¹³C NMR (75 MHz, CDCl₃) δ 170.7, 132.6, 119.1, 82.3, 63.7, 36.1, 28.1, 27.0. Reference: Zhang, Y.; Raines, A. J.; Flowers, R. A. II. J. Org. Chem. 2004, 69, 6267.

### General Chemical Procedure for the Allylic Alkylation of tert-Butyl Acetoacetate with Allyl Methyl Carbonate

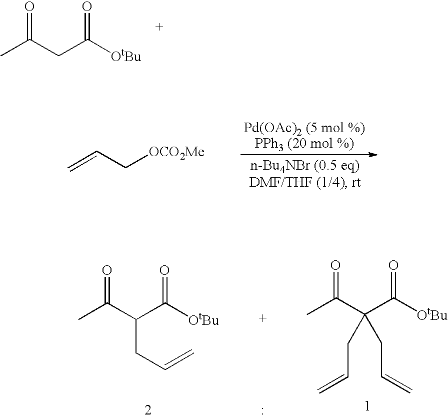

To a 50 mL round bottom flask with a mixture of allyl methyl carbonate (2.0 mmol), tert-butyl acetoacetate (2.4 mmol), Pd(OAc)₂ (22.4 mg, 0.1 mmol), PPh₃ (104.9 mg, 0.4 mmol) and tetrabutylammonium bromide (322.4 mg, 1.0 mmol) was added a solution of 2 mL of DMF in 8 mL of THF. The resulting brown solution was stirred for 24 h at room temperature under an argon atmosphere. 1 M HCl was then added to the reaction mixture until pH<5. The resulting suspension was extracted with CH₂Cl₂ (3×20 mL). The combined organic layer was first washed with water and brine, and then poured into a short pad column with silica gel eluting with CH₂Cl₂. The CH₂Cl₂ elute was concentrated under reduced pressure. The residue was further subjected to column chromatography eluting with hexane/ethyl acetate (20/1) to yield mono- and di-allylated products in a ratio of 2/1.

### General Electrochemical Procedure for the Allylic Alkylation of tert-Butyl Acetoacetate with Either Allylbromide or Allylacetate

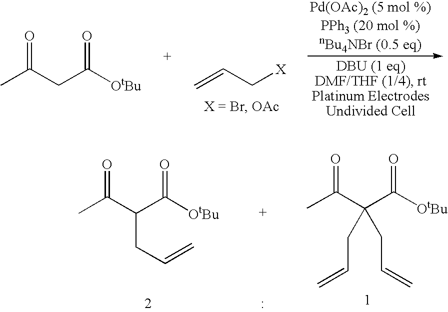

To a 25 mL round bottom flask with a mixture of allyl bromide or allyl acetate (2.0 mmol), tert-butyl acetoacetate (2.4 mmol), Pd(OAc)₂ (22.4 mg, 0.1 mmol), PPh₃ (104.9 mg, 0.4 mmol) and tetrabutylammonium bromide (322.4 mg, 1.0 mmol) was added a solution of 2 mL of DMF, 8 mL of THF and 0.3 mL of DBU (2.0 mmol). The resulting brown solution was electrolyzed for 3-4 h with constant current (20 mA) on platinum electrodes at room temperature under an argon atmosphere. 1 M HCl was then added to the reaction mixture until the pH was less than 5. The resulting suspension was extracted with CH₂Cl₂ (3×20 mL). The combined organic layer was first washed with water and brine, and then poured into a short pad column with silica gel eluting with CH₂Cl₂. The CH₂Cl₂ elute was concentrated under reduced pressure. The residue was further subjected to column chromatography eluting with hexane/ethyl acetate (20/1) to yield mono- and di-allylated products in a ratio of 2/1.

### General Electrochemical Procedure for the Allylic Alkylation of tert-Butyl Acetoacetate with Allyl Methyl Carbonate

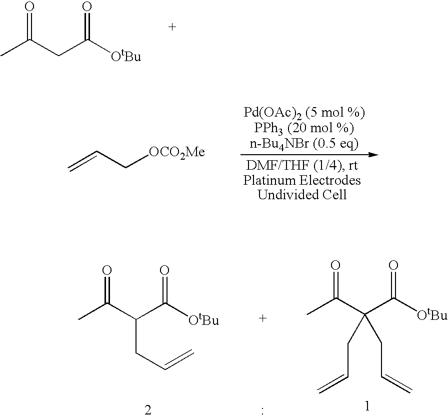

To a 25 mL round bottom flask with a mixture of allyl bromide or allyl acetate (2.0 mmol), tert-butyl acetoacetate (2.4 mmol), Pd(OAc)₂ (22.4 mg, 0.1 mmol), PPh₃ (104.9 mg, 0.4 mmol) and tetrabutylammonium bromide (322.4 mg, 1.0 mmol) was added a solution of 2 mL of DMF, 8 mL of THF and 0.3 mL of DBU (2.0 mmol). The resulting brown solution was electrolyzed for 6 h with constant current (20 mA) on platinum electrodes at room temperature under an argon atmosphere. 1 M HCl was then added to the reaction mixture until pH<5. The resulting suspension was extracted with CH₂Cl₂ (3×20 mL). The combined organic layer was first washed with water and brine, and then poured into a short pad column with silica gel eluting with CH₂Cl₂. The CH₂Cl₂ elute was concentrated under reduced pressure. The residue was further subjected to column chromatography eluting with hexane/ethyl acetate (20/1) to yield mono- and di-allylated products in a ratio of 2/1.

We claim:

1. A process for conducting a transition metal-catalyzed allylic alkylation reaction on a plurality of electrodes, comprising:
(a) contacting an electrode array device with a solution comprising a transition metal catalyst in an inactive state, a confining agent, an electrolyte, and a nucleophile, wherein the electrode array device comprises a plurality of individually addressable electrodes, each electrode having an allylic substrate immobilized proximally thereto; and
(b) selectively biasing one or more of the electrodes with a voltage or current to reduce the transition metal catalyst in an inactive state to provide a transition metal catalyst in an active state, wherein the transition metal catalyst in the active state catalyzes the covalent coupling of the nucleophile to the allylic substrate to provide an immobilized allylic alkylation product.

2. The process of claim 1, wherein the transition metal catalyst is selected from the group consisting of a palladium, platinum, nickel, and cobalt catalyst.

3. The process of claim 1, wherein the transition metal catalyst is stabilized with a ligand selected from the group consisting of a phosphine ligand, a phosphite ligand, an arsenic derivative, a triphenylphosphine ligand, metal carbonyl, and combinations thereof.

4. The process of claim 1, wherein the confining agent limits diffusion of the transition metal catalyst in the active state to a volume surrounding each electrode.

5. The process of claim 1, wherein the confining agent is an oxidant present in the solution in an amount effective to convert the transition metal catalyst in the active state to the transition metal catalyst in the inactive state.

6. The process of claim 1, wherein the confining agent is quinone.

7. The process of claim 1, wherein the nucleophile is selected from the group consisting of doubly activated methylene groups, alcohols, and amines.

8. The process of claim 7, wherein nucleophile is a β-ketoester.

9. The process of claim 1, wherein the allylic substrate is selected from the group consisting of allyl carbonates, allyl halides, and allyl esters.

10. The process of claim 1, wherein biasing one or more of the electrodes with a voltage comprises applying a voltage less than about 3.0 V.

11. The process of claim 1, wherein biasing one or more of the electrodes with a voltage comprises applying a voltage for from about 0.5 sec to about 3 min.

12. The process of claim 1, wherein the electrolyte is tetrabutylammonium bromide.

13. A process for attaching an allylation substrate proximally to a plurality of electrodes, comprising:
(a) contacting an electrode array device with an organic solution comprising an allylation substrate, a base, and an electrolyte, wherein the electrode array device comprises a plurality of individually addressable electrodes, each having a porous reaction layer proximal thereto, wherein the porous reaction layer has reactive hydroxyl groups; and
(b) selectively biasing one or more of the electrodes with a voltage or current to provide a reduced base, wherein the reduced base triggers a based-catalyzed esterification reaction between the porous reaction layer and the allylation substrate, whereby the allylation substrate attaches to the porous reaction layer.

14. The process of claim 13, wherein the porous reaction layer comprises agarose.

15. The process of claim 13, wherein the allylation substrate is an N-hydroxysuccinimide ester.

16. The process of claim 15, wherein the N-hydroxysuccinimide ester is selected from the group consisting of an allyl bromide N-hydroxysuccinimide, an allyl acetate N hydroxysuccinimide, and an allyl carbonate N-hydroxysuccinimide.

17. The process of claim 13, wherein the base is azobenzene.

18. The process of claim 13, wherein the electrolyte is tetrabutylammonium bromide.

19. A microarray having a plurality of allylation substrates attached thereto, comprising:
(a) a substrate having a plurality of known locations;
(b) a porous reaction layer attached to the substrate and covering the known locations; and
(c) a plurality of allylation substrates attached to the porous reaction layer at the known locations.
